(19) United States
(12) Patent Application Publication
(10) Pub. No.: US 2008/0079852 A1
(43) Pub. Date: Apr. 3, 2008

(54) VIDEO DISPLAY METHOD, VIDEO SIGNAL PROCESSING APPARATUS, AND VIDEO DISPLAY APPARATUS

(75) Inventors: Michihiro NAGAISHI, Okaya-shi (JP); Toyoaki KOMATSU, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/851,854

(22) Filed: Sep. 7, 2007

(30) Foreign Application Priority Data
Oct. 2, 2006 (JP) 2006-270456
Oct. 2, 2006 (JP) 2006-270457

(51) Int. Cl. H04N 9/12

(52) U.S. Cl. 348/739; 348/E09.012

(57) ABSTRACT

A video display method is used in a display device that displays images in correspondence with frames or fields defined by a video signal on the basis of the video signal. The video display method includes a step of generating mask patterns in correspondence with frames or fields defined by the video signal such that the mask patterns corresponding to consecutive frames or fields defined by the video signal are different from each other. The mask patterns include randomly arranged black and white dots or patterns. At least one of the images is displayed on the basis of the video signal and then at least one of the generated mask patterns is displayed.

### BACKGROUND

1. Technical Field

The present invention relates to technology for reducing motion blur in a case where a video signal such as a television signal is displayed by using a liquid crystal device or the like.

2. Related Art

Liquid crystal devices, active matrix organic EL devices, and the like are hold-type display devices in which a display image is maintained over one frame period (16.7 milliseconds). In the hold-type display devices, when transition to the next frame is made, the image of the previous frame is retained as a retinal afterimage. Accordingly, when there is a motion being shown in images displayed in consecutive frames, a moving area is perceived to be unnatural or an outline thereof is perceived to be blurred. In other words, motion blur occurs.

On the other hand, CRTs are impulse-type display devices in which an image is displayed momentarily. In the impulse-type display devices, since retinal retention of an image displayed in the previous frame does not remain when transition to the next frame is made, motion blur does not occur. Thus, in the hold-type display devices, technology for inserting a black screen after display of an image so as to improve a display characteristic thereof to be similar to that of the impulse-type display devices has been disclosed (see JP-A-4-302289).

Here, when a black screen is inserted in a simple manner, luminance of the displayed screen decreases. Thus, technology in which one black screen is inserted into a plurality of frames by assigning areas in a predetermined order over the plurality of frames and displaying the area assigned to each frame in black has been proposed (JP-A-2005-10579).

However, when the technology in which one black screen is inserted into a plurality of frames is used, an area to be displayed in black is temporally (for each frame) moved. Thus, there is a possibility that the area is perceived or causes flicker. In addition, there is a problem that the luminance of a display screen may easily decreases.

### SUMMARY

An advantage of some embodiments of the invention is that it provides a video display method and a video signal processing apparatus which improve display characteristics of moving images without decreasing the luminance of a display screen.

Visual information is memorized as a temporary experience even after it disappears momentarily. The retinal image retention can be classified into several types depending on a lasting period thereof. Among these types of retinal image retention, the shortest-term retinal image retention is called iconic memory and is thought to be closely related with perception of motional blur. The iconic memory can be erased by providing a mask in a same position right after stimulation of visual perception.

In the above described technology for insertion of a black screen after display of an image, the black screen corresponds to the mask. By using this technology, although the motion blur can be prevented, average luminance per unit time (for example, a frame period) decreases corresponding to insertion of black screens, whereby the whole screen is viewed darkly.

According to a first embodiment of the invention, video display method is used in a display device that displays images in correspondence with frames or fields defined by a video signal on the basis of the video signal. The video display method includes a step of generating mask patterns in correspondence with frames or fields defined by the video signal such that the mask patterns corresponding to consecutive frames or fields defined by the video signal are different from each other. The mask patterns include randomly arranged black and white dots or patterns. At least one of the images is displayed on the basis of the video signal and then at least one of the generated mask patterns is displayed.

When a motion picture is to be displayed, if images are displayed for each frame or field, the displayed images are visually memorized. However, according to an embodiment of the invention, by displaying the mask patterns, the visual memory is erased (or weakened), and accordingly, perception of motion blur is suppressed. In addition, since the mask pattern includes white dots, decrease of luminance of the screen per unit time is prevented. In addition, since the mask pattern generating unit may randomly generate black and white dots, a circuit structure thereof can be simplified. In addition, since the mask patterns are generated for each frame or field such that black and white dots or patterns are randomly arranged, the mask patterns displayed for consecutive frames or fields are different from each other. Thus, the mask patterns can not perceived. In addition, as shown in FIG. 4A, although the black and white dots may be randomly arranged over the whole screen, since a point of sight is easily positioned toward the center of the screen, the black dots may be concentrated around the center of the screen, as shown in FIG. 4B. In addition, as shown in FIG. 4B, it is preferable to concentrate the black dots in an area having the center of the screen as its center and occupying about 70% of the whole screen area (where an area formed by connecting four corners of the screen is 100%). In addition, as shown in FIG. 4C, the dots may be in the shape of a continuous or discontinued rod, a character, or any other pattern. Even the pattern shown in FIG. 4C can be actually constituted by only black and white dots.

It is preferable that the displaying of the image is performed on the basis of a read video signal in a period shorter than that of the frame or field defined by the video signal by storing the video signal in a memory and then reading the video signal from the memory at a speed faster than a speed at which the video signal is stored and the displaying of the corresponding mask patter involves displaying the mask pattern at least for a part of a remaining period of the frame or field after the image has been displayed on the basis of the read video signal. In this method, images on the basis of the video signal may be displayed a plurality of times in one frame, and some of the images displayed the plurality of times may be intermediate images generated by an interpolation method or the like.

The video display method may further include displaying a white or gray image after displaying the mask pattern for the part of the remaining period. By using this method, since average luminance of the screen per unit time does not decrease by displaying white or gray after display of the mask pattern, darkening of the screen is prevented.

Furthermore, the present invention can be implemented as a video signal processing apparatus and a video display apparatus along with a video display method.

According to another embodiment, a moving area in the images is detected on the basis of the video signal. The mask patterns are generated for the moving area and a peripheral area thereof of the frames or fields.

When a motion picture is to be displayed, if images are displayed for each frame or field, the displayed images are visually memorized. However, according to this embodiment, by displaying mask patterns in which black dots are concentrated to be randomly arranged in a moving area and a peripheral area thereof, visual memory, particularly visual memory of the moving area, is effectively erased (or weakened), and accordingly, the visual characteristics of moving images are improved. In addition, since the mask pattern includes white dots, decrease of luminance of the screen per unit time is prevented. In addition, since the mask pattern generating unit may randomly generate black and white dots, a circuit structure thereof can be simplified. In addition, since the mask patterns are generated for each frame or field such that black and white dots or patterns are randomly arranged, the mask patterns displayed for consecutive frames or fields are different from each other. Thus, the mask patterns can not perceived. In addition, as shown in FIG. 4A, although the black and white dots may be randomly arranged over the whole screen, since a point of sight is easily positioned toward the center of the screen, the black dots may be concentrated around the center of the screen regardless of the moving area, as shown in FIG. 4B. In addition, as shown in FIG. 4B, is preferable to concentrate the black dots in an area having the center of the screen as its center and occupying about 70% of the whole screen area (where an area formed by connecting four corners of the screen is 100%). In addition, as shown in FIG. 4C, the dots may be in the shape of a continuous or discontinued rod, a character, or any other pattern. The pattern shown in FIG. 4C can be actually constituted by only black and white dots.

It is preferable that the displaying of the image involves displaying the image on the basis of a read video signal for a period shorter than that of the frame or field defined by the video signal by storing the video signal in a memory and then reading the video signal from the memory at a speed faster than a speed at which the video signal is stored and the displaying of the mask pattern involves displaying the mask pattern at least for a part of a remaining period of the frame or field after the image on the basis of the read video signal has been displayed. In this method, images on the basis of the video signal may be displayed a plurality of times in one frame, and some of the images displayed the plurality of times may be intermediate images generated by an interpolation method or the like. In addition, a moving area over a plurality of frames or fields may be detected and black dots may be concentrated in the moving area and a peripheral area thereof. Accordingly, visual memory, particularly visual memory of the moving area, is effectively erased, and thus, the visual characteristics of moving images are improved.

In addition, the video display method may further include displaying a white or gray image after displaying the mask pattern for the part of the remaining period. In such a case, since average luminance per unit time does not decrease by displaying white or gray after display of the mask pattern, darkening of the screen is prevented.

Furthermore, the present invention can be implemented as a video signal processing apparatus and a video display apparatus along with a video display method.

### BRIEF DESCRIPTION OF THE DRAWINGS

The invention will be described with reference to the accompanying drawings, wherein like numbers reference like elements.

FIG. 1 is a diagram showing a screen in a video display method according to a first embodiment of the present invention.

FIG. 2A is a diagram showing a display period in a video display method according to the first embodiment of the invention.

FIG. 2B is a diagram showing viewer's perception of display in a video display method according to the first embodiment of the invention.

FIG. 3A is a diagram showing a video display method according to the first embodiment of the invention.

FIG. 3B is a diagram showing a known video display method.

FIGS. 4A to 4C are diagrams showing mask patterns according to the first embodiment of the invention as an example.

FIG. 5 is a diagram showing a structure of a video signal processing apparatus according to the first embodiment of the invention.

FIG. 6 is a flowchart showing operations of the video signal processing apparatus according to the first embodiment of the invention.

FIG. 7 is an example of generation of mask patterns according to the first embodiment of the invention.

FIG. 8 is an example of mask patterns according to the first embodiment of the invention.

FIG. 9 is an example of mask patterns according to the first embodiment of the invention.

FIG. 10 is a diagram showing an example of display in a case where triple speed or quad speed is used according to the first embodiment of the invention.

FIG. 11 is a diagram showing a structure or a projector using a video signal processing apparatus according to the first embodiment of the invention.

FIG. 12 is a diagram showing a structure of a video signal processing apparatus according to a second embodiment of the invention.

FIG. 13 is a flowchart showing operations of a video signal processing apparatus according to the second embodiment of the invention.

FIG. 14A is a diagram showing a screen processed by a video signal processing apparatus according to the second embodiment of the invention, in a temporal sequence.

FIG. 14B is a diagram showing another screen processed by a video signal processing apparatus according to the second embodiment of the invention, in a temporal sequence.

FIG. 15 is an example of generation of mask patterns according to the second embodiment of the invention.

FIG. 16 is a diagram showing concentration density of mask patterns according to the second embodiment of the invention.

### DESCRIPTION OF EXEMPLARY EMBODIMENTS

### First Embodiment

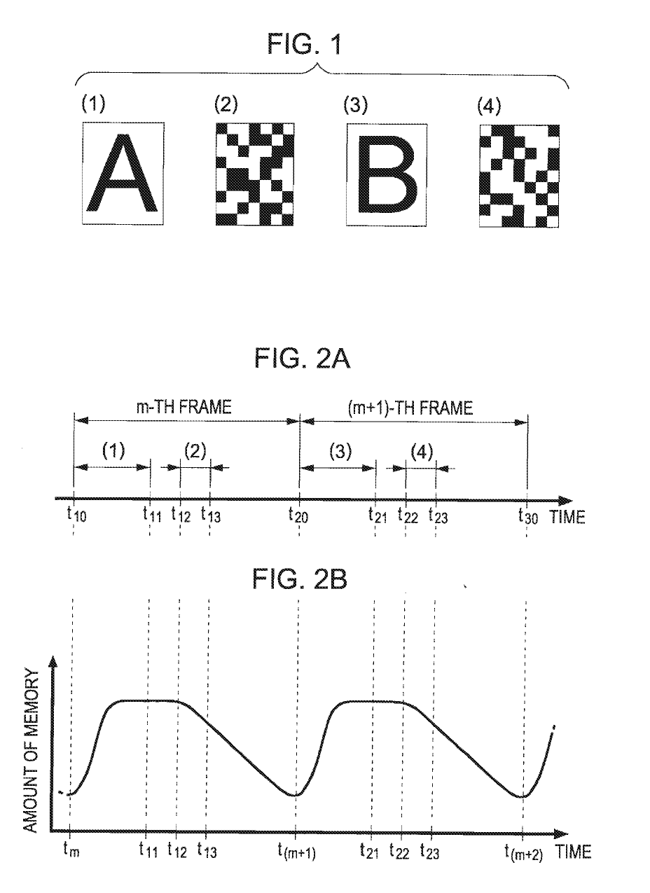

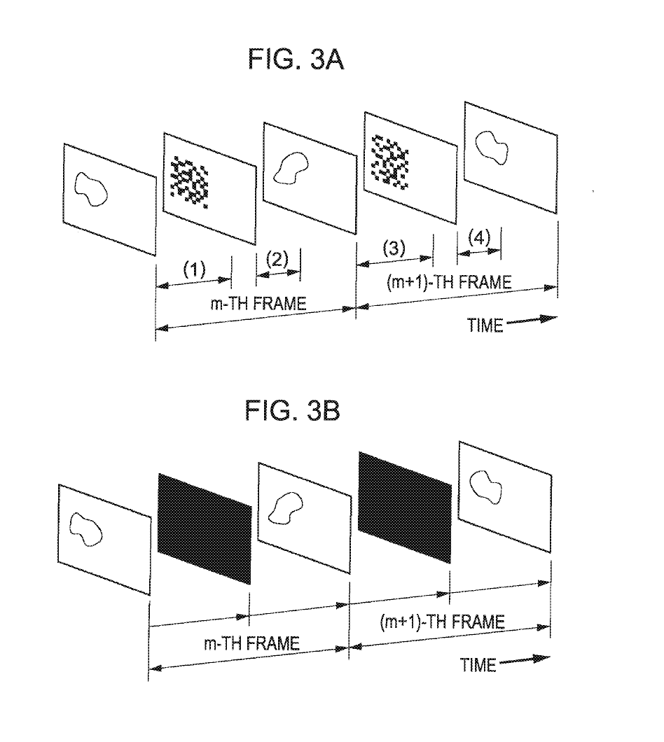

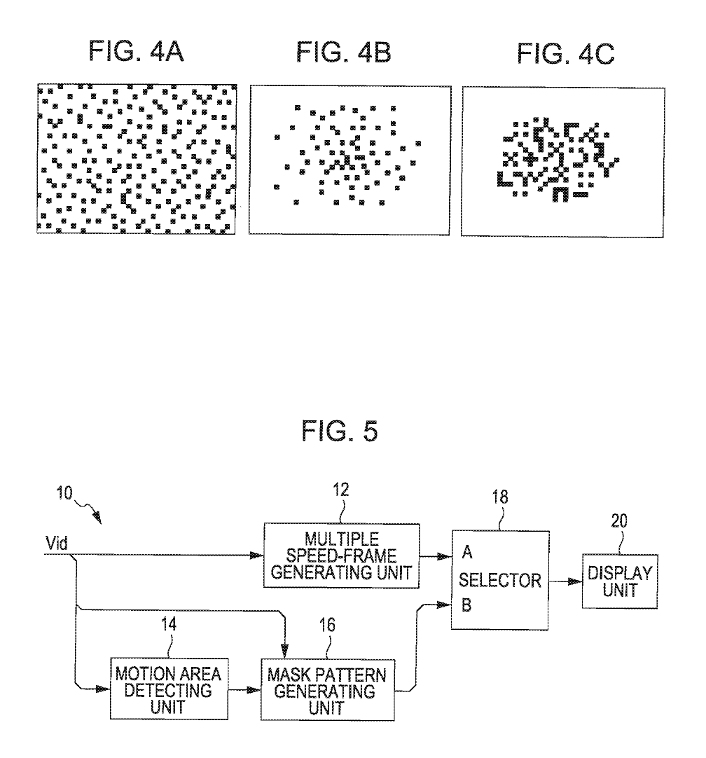

FIG. 1 is a diagram showing an image display sequence in a video display method according to a first embodiment of the present invention. FIGS. 2A and 3A are diagrams showing a display period of images as an example. FIG. 2B is a diagram showing a viewer's perception of the display.

In FIG. 1, an image denoted by “(1)” is a scan screen, which is displayed as a frame (referred to as “m-th frame” for the convenience of description), among scan screens on the basis of video signals supplied in a non-interlaced format (sequential scanning). An image denoted by “(3)” is a scan screen displayed in accordance with the next frame (referred to as “(m+1)-th frame”).

Here, a case where a non-interlaced format is used is described. The number of frames per second is, for example, 60, and a period of one frame is 16.7 milliseconds (a reciprocal number of 60 Hz).

In this embodiment, as shown in FIGS. 2A and 3A, a screen (1) defined by a video signal is displayed from the start of a frame period, and then a mask pattern (2) is displayed.

In particular, the scan screen (1) of the m-th frame is displayed from start time t10 to time t11 an m-th frame period. Thereafter, a mask pattern (2) is displayed from time t12 to time t13, which is a part of a remaining period of one frame period. Likewise for the next (m+1)-th period, a scan screen (3) of the (m+1)-th frame is displayed from start time t20 to time t21 in an (m+1)-th frame period. Thereafter, a mask pattern (4) is displayed from time t22 to time t23, which is a part of a remaining period of one frame period.

Although, the time period from time t10 to time t11 for displaying the scan screen (1) and the time period from time t20 to time t21 for displaying the scan screen (3) vary depending on a display device of the scan screens, the time periods are, for example, about half one frame. The time period from time t12 to time t13 for displaying the mask pattern (2) and the time period from time t22 to time t23 for displaying the mask pattern (4) are about several milliseconds (preferably, about 9 millisecond). In practical use, the periods and timings for displaying the mask patterns are determined on the basis of the response time of the display device displaying the scan screens, the mask patterns, and the like.

Here, the mask pattern (2) that is displayed after the scan screen (1) of the m-th frame, as shown in the figure, is a pattern in which black and white dots are randomly arranged regardless of the scan screen (1). Likewise, the mask pattern (4) that is displayed after the scan screen (3) of the (m+1)-th frame is a pattern in which black and white dots are randomly arranged regardless of the scan screen (3). As described above, since the mask patterns (2) and (4) are patterns in which black and white dots are randomly arranged, they are different from each other without forming any relationship therebetween.

Here, a case where the ratio of the number of the black dots generated to the number of white dots generated, for example, is a constant ratio of 6 to 4 will be described. However, to be described later, the ratio of the number of black dots generated to the number of white dots generated may vary in a fixed range depending on a time or a position of the screen.

By using this video display method, the scan screens (1) and (3) are displayed like an impulse not for the whole one frame, but for a part of the one frame. In other words, an image displayed as consecutive frames is divided temporally. Accordingly, perception of frames mixed with each other can be prevented, and it is possible to improve display characteristics of a display image, and more particularly, display characteristics of moving images.

Furthermore, a mask pattern is displayed after the scan screen (1) of the m-th frame. Thus, image retention generated by perception of the scan screen (1) has decreased sufficiently by the time the next (m+1)-th frame is displayed. The same operation is performed for the scan screen (3) of the next (m+1)-th frame. As a result, separation between the scan screens (1) and (3) for a viewer can be further improved, and accordingly, it is possible to suppress generation of blur in a motion picture. FIG. 2B is a diagram showing a result of a psychological experiment showing changes in viewer image retention (strength of memory) with time when the scan screen (1), the mask pattern (2), the scan screen (3), and the mask pattern (4) are displayed. From the figure, it can be noticed that the image retention of the scan screen (1) of the m-th frame gradually decreases when displaying the mask pattern (2).

The mask patterns (2) and (4) are random patterns without any meaning and are not related to each other. In addition, the display periods of the mask patterns (2) and (4) are shorter than the scan screens (1) and (3). Accordingly, the mask patterns are not perceived as an image constituting a motion picture and generation of flicker due to display of similar patterns for each frame period is suppressed.

Furthermore, the mask patterns (2) and (4) include white dots. Thus, as shown in FIG. 3B, a decrease in the average luminance per unit time is suppressed, compared with a case where the mask patterns are constituted by only black dots (black screens) and the black screens are displayed for the whole remaining period after display of the scan screens. Accordingly, it is possible to prevent darkening of the screens.

Hereinafter, a video signal processing apparatus for implementing this video display method will be described with reference to FIG. 5.

As shown in the figure, the video signal processing apparatus 10 performs signal processing for a video signal Vid supplied from an external higher-level device (not shown) and supplies the processed signal to a display unit 20. The video signal processing apparatus 10, for example, is connected to an input terminal of the display unit 20 as an adapter. The video signal processing apparatus 10 includes a multiple-speed frame generating unit 12, a moving area detecting unit 14, a mask pattern generating unit 16, and a selector 18.

Among these components, the multiple-speed frame generating unit 12 has an internal memory. The multiple-speed frame generating unit 12 temporarily stores the video signal Vid supplied from the higher-level device in the memory and reads the video signal from the memory at a speed (here, a double speed) higher than a speed at which the video signal is stored in the memory. The multiple-speed frame generating unit 12 supplies the read video signal Vid to one input terminal A of the selector 18. The video signal Vid is supplied in a format in which image for one frame is scanned on a screen over one frame period. Thus, the scan screen defined by the video signal Vid cannot be displayed in a period shorter than the frame period. However, since a supply period (a period required for scanning one screen) of the video signal Vid is temporally compressed by the multiple-speed frame generating unit 12, a scan screen of one frame defined by the video signal Vid can be output as the m-th frame in a period from time t10 to time t11.

The moving area detecting unit 14 detects the amount of motion and screen position of an area in which motion exists by comparing scan screens, which are based on the video signal Vid, over a plurality of frames.

The mask pattern generating unit 16, as will be described later, generates a mask pattern. The mask pattern generating unit 16 supplies a video signal representing the generated mask pattern to the other input terminal B of the selector 18 after the multiple-speed frame generating unit 12 reads the video signal.

In addition, the mask pattern generating unit 16 generates a mask pattern such that black and white dots are randomly arranged in an area including a moving area and a peripheral area thereof. Thus, a detection result detected by the moving area detecting unit 14 is input to the mask pattern generating unit 16. In addition a video signal Vid that defines vertical scanning and horizontal synchronization is input to the mask pattern generating unit 16 from a higher-level device for determination of generation timing of a mask pattern.

The selector 18 selects the input terminal A when a video signal is read from the memory by the multiple speed frame generating unit 12. Then, the selector 18 supplies the read video signal to the display 20. On the other hand, the selector 18 selects the input terminal B when a video signal representing a mask pattern is supplied by the mask pattern generating unit. Then, the selector 18 supplies the video signal of the mask pattern to the display unit 20.

The display unit 20 performs display on the basis of the video signal supplied through the selector 18. When the video signal is read by the multiple-speed frame generating unit 12, the display unit 20 displays a scan screen on the basis of the read video signal. On the other hand, when the video signal representing the mask pattern is supplied by the mask pattern generating unit, the display unit 20 displays the mask pattern. In addition, the display unit 20, for example, includes a liquid crystal panel, an organic EL panel, or the like. The display unit 20 has pixels arranged in correspondence with intersections of scan lines and data lines. The display unit 20 sequentially selects the scan lines row by row and supplies a data signal of a voltage or current corresponding to a gray scale level to pixels located in the selected row through the data lines. Each pixel comes to have a gray scale level corresponding to the voltage or current of the data signal supplied to the data lines at a time when a row corresponding thereto is selected and then maintains the gray scale level even after the selection of the scan line is over. Furthermore, the display unit 20 is not limited thereto and may include any other display device as long as it displays a screen on the basis of the video signal.

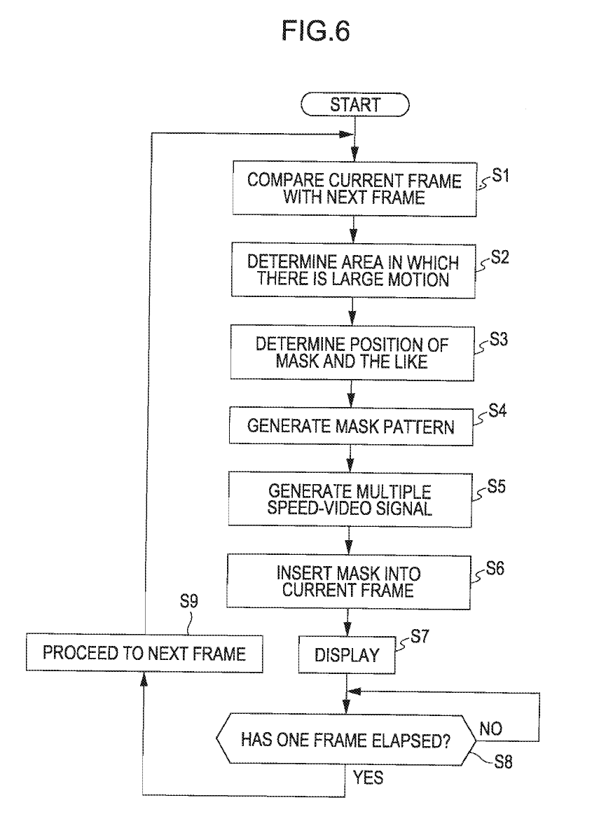

Next, operations of the video signal processing apparatus 10 will be described. FIG. 6 is a flowchart showing the operations of the video signal processing apparatus 10.

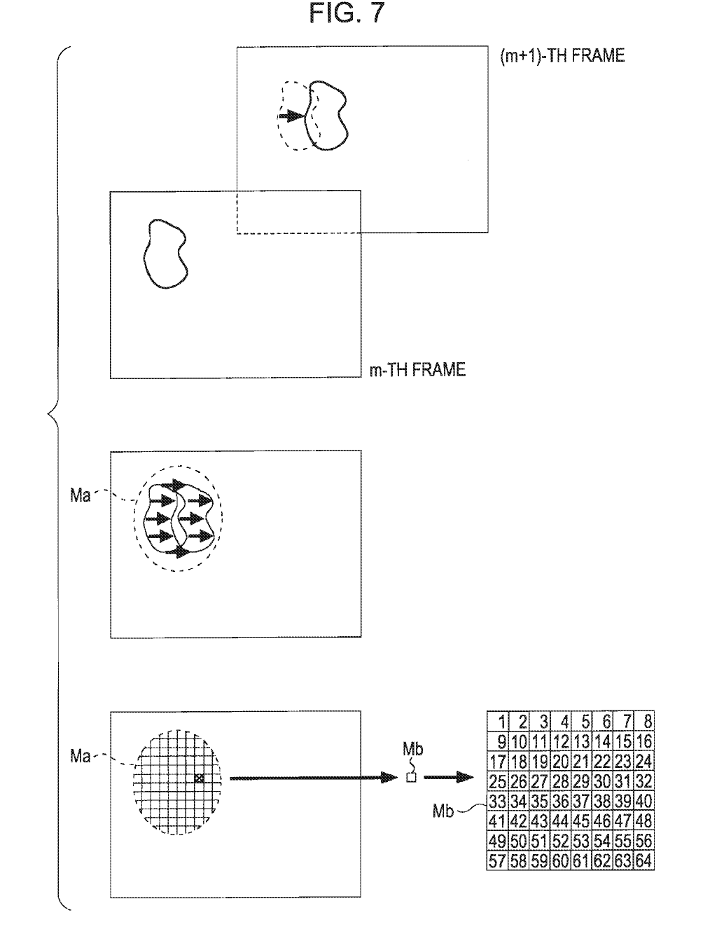

In step S1, the moving area detecting unit 14 compares scan screens, which are based on the video signals Vid supplied from the higher-level device, for two frames. In step S2, the moving area detecting unit 14 determines an area in which a motion exists on the basis of a result of the comparison of the two frames. In particular, when the m-th frame is considered, as shown in FIG. 7, a motion vector is extracted by calculating a difference between a scan screen of the current m-th frame and a scan screen of the next (m+1)-th frame. Accordingly, it is possible to determine the location of a moving area. In FIG. 7, an area indicated by a right arrow is determined to be a moving area.

Since the (m+1)-th frame comes later than the m-th frame, at least the video signals Vid for the m-th and the (m+1)-th frames are stored for the comparison.

In step S3, the moving area detecting area 14 determines an area Ma which includes a moving area and is slightly larger than the moving area to be a mask area for the arrangement of black and white dots.

in step S4, the mask pattern generating unit 16 generates a mask pattern, for example, by the following method. In other words, the mask pattern generating unit 16 divides the determined area Ma, for example, into small areas Mb of 8×8 dots. Then, the mask pattern generating unit 16, as shown in the figure, assigns numbers of “1” to “64” to each dot of 8×8 dots of the divided small areas Mb. Then, the mask pattern generating unit 16 assigns numbers of “1” to “64” to each dot, to which a number is assigned, as random numbers. Then, the mask pattern generating unit 16 compares the assigned numbers (random numbers) with a threshold value. Then, the mask pattern generating unit 16 sets dots having assigned numbers equal to or greater than the threshold value as black dots. The mask pattern generating unit 16 performs the above-described operation for the whole divided small areas Mb.

Here, when the threshold value is set to be small, the number of black dots increases relatively. To the contrary, when the threshold value is set to be large, the number of black dots decreases relatively. Accordingly, when a distribution pattern in which the threshold value set for the small areas Mb increases as the small areas Mb become far apart from the center of the area Ma is used, the black dot density decreases as the small area becomes distant from the center of the area Ma.

In step S2, if the extracted motion vector is large, it indicates that the moving area moves rapidly. In such a case, if the threshold value set for the above-described distribution pattern is decreased, the proportion of generation of black dots generated increases, whereby the effect of reducing image retention is improved. On the other hand, if the extracted motion vector is small in magnitude, the threshold value to be set is increased.

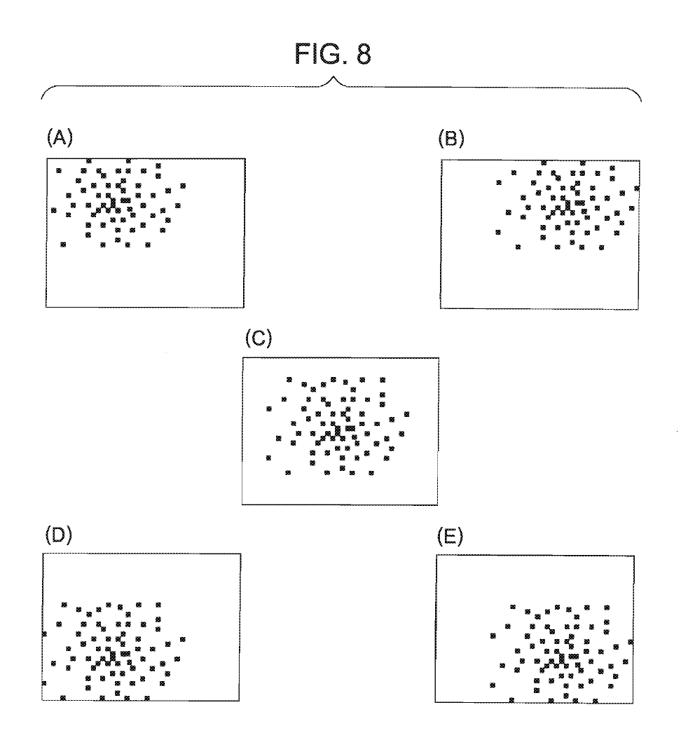

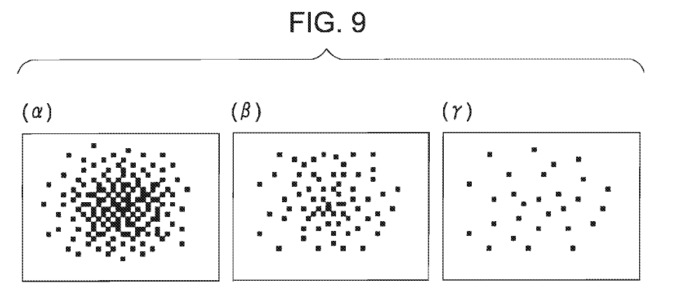

An example of mask patterns generated by the mark pattern generating unit 16 is shown in FIGS. 8 and 9.

In FIG. 8, a pattern A is a case where the area Ma is set in the upper-left side of the screen. Similarly, patterns B, C, D, and E are cases where the area Ma is set on the upper-right, center, lower-left, and lower-right sides of the screen.

In FIG. 9, a pattern α is a case where the proportion of black dots generated increases due to a large motion vector. Patterns β and γ are cases where the proportions of black dots generated sequentially decrease as the motion vectors gradually decreases in magnitude. FIG. 9 shows a case where the area Ma is set in the center on the screen, and actually, mask patterns combining a position change on the screen shown in FIG. 8 and a change in the black dot density are generated.

Alternatively, the mask area may be determined on the basis of the position of the moving area and the proportion of black dots may not be changed on the basis of the magnitude of the motion vector. Furthermore, when the magnitude of the motion vector is zero or sufficiently small, it indicates no movement between the scan screens of both the frames, that is, still screens, and accordingly, the mask pattern is not be generated.

In step S5, the multiple-speed frame generating unit 12 supplies the scan screen of one frame in a period half that of the one frame by temporarily storing the video signal Vid supplied from the higher-level device in the memory and then reading the video signal from the memory at a speed higher than a speed at which the video signal is stored.

In step S6, the mask pattern generating unit 16 supplies a video signal representing the generated mask pattern to an input terminal B of the selector 18.

The selector 18 selects the input terminal A in a period that the multiple-speed frame generating unit 12 reads a video signal from the memory and selects the input terminal B in a period that a video signal representing the mask pattern generated by the mask pattern generating unit 16 is supplied, thereby supplying the video signal to the display unit 20 (step S7).

Accordingly, for the m-th frame, a scan screen on the basis of the video signal Vid is displayed from time t10 to time t11, and then, a mask pattern for erasing retinal retention of the scan screen is displayed from time t12 to time t13.

When it is determined that one frame period has not elapsed due to the supply of the video signal Vid (step S8: No), the multiple-speed frame generating unit 12 waits until the one frame period elapses. On the other hand, when it is determined that one frame period has elapsed (step S8: Yes) the next frame becomes a target frame to be processed in step S9. In other words, for example, a process in which a reading pointer (address) for the memory is set to a leading part of a video signal of the next frame or the like is performed.

Then, the process proceeds back to step S1. Accordingly, the process of steps S1 to S9 is repeated for each frame.

As described above, when a video signal Vid is input to the video signal processing apparatus 10, a mask pattern that is inserted between scan screens on the basis of the video signal Vid is displayed in the display unit 20. The mask pattern of black and white dots is arranged in a moving area of the scan screen and a peripheral area thereof. Accordingly, generation of motion blur is effectively suppressed.

Here, although a case where a non-interlaced format is used has been described, the scan mode may be an interlaced format (interlaced scanning). In such a case, the number of frames per second is reduced by half to “30”. However, since a screen of one frame is completed by two scan screens corresponding to two fields, a period required for scanning one scan screen is 16.7 milliseconds, which is the same as in the non-interlaced format. When the interlaced format is used, one scan screen is completed in one field period, and thus, the mask pattern is displayed after the scan screen is displayed in a period shorter than one field period.

In this embodiment, the video signal Vid stored in the memory is read at double speed, and as shown in FIGS. 2 and 3, the mask pattern is inserted between the scan screens. However, when the display unit 20, for example, is a liquid crystal panel, the video signal may be read at triple speed or quad speed rather than double speed.

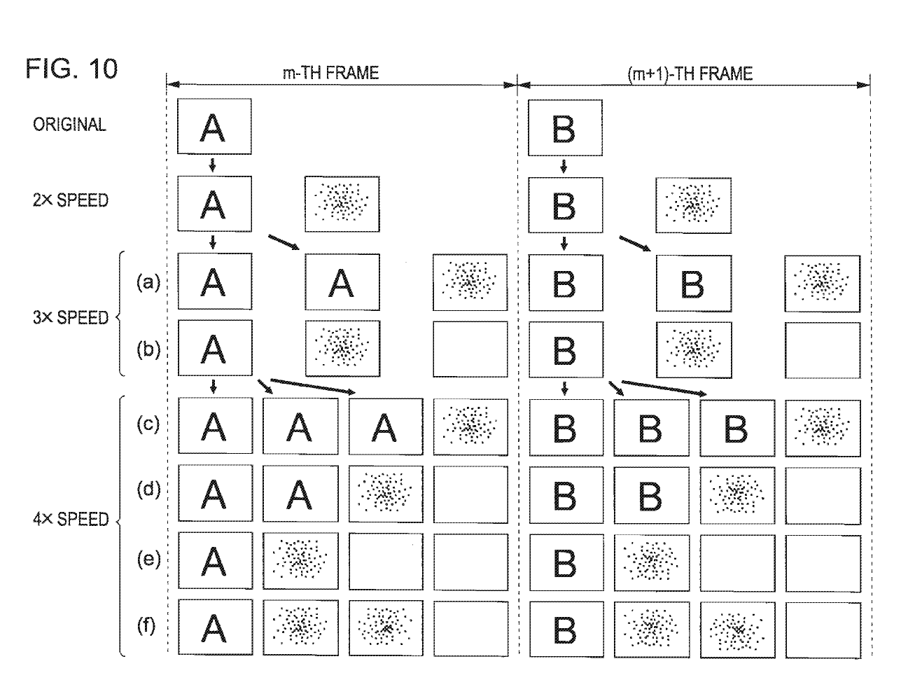

FIG. 10 is a diagram snowing an example of insertion of a mask pattern when the video signal is read at double speed, triple speed, or quad speed.

As described above, the mask pattern is used for erasing retinal retention of display after the display of a scan screen and may be displayed for several milliseconds preferably. Thus, if a scan screen of a frame is displayed on the first screen of the frame, other screens may be displayed in any sequence.

For example, as shown in a triple speed pattern (b) or a quad speed pattern (e), average luminance may be acquired by setting the mask pattern in the second screen and setting white in the third screen and thereafter. Alternatively, the third screens and thereafter may be set in black, although luminance of the screen decreases. This also applies to blank screens (fourth screens, of the quad speed patterns (d) and (f).

Furthermore, as shown in the quad speed pattern (f), the second and third screens may be other mask patterns.

As described above, although a display operation of the display unit 20 is required to perform at high speed when a multiple-speed process such as triple speed process or quad speed process is performed, it is possible to more delicately set the display period and timing of a mask pattern and the like than in a case where double speed is used.

In the example shown in FIG. 10, although the second screen in the triple speed pattern (a) and the quad speed pattern (d) and the second and third screens in the quad speed pattern (c) are configured to be the same as the first screen that is the scan screen, intermediate images may be generated by interpolating frames and mask patterns may be inserted between the intermediate images.

Furthermore, even when the process for multiple speed is performed, while the scan screen of the current frame is displayed on the first screen, the first screen may be copied into the second screen or a screen thereafter, and the mask pattern may be displayed on the third screen or a screen thereafter.

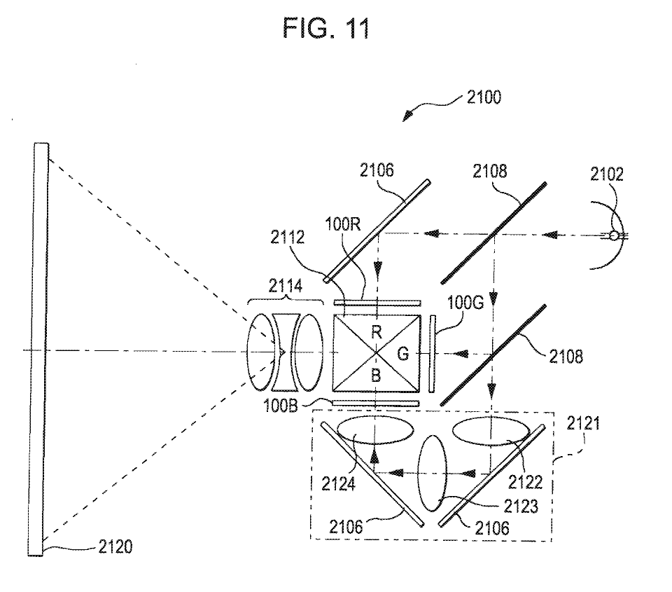

Hereinafter, a case where the above-described display method according to an embodiment of the invention is used in a video display apparatus will be described. FIG. 11 is a plan view showing a structure of a three-plate projector in which the above-described display unit 20 used as a light valve of R, G, and B.

In the projector 2100, light made to be incident on the light valve is divided into three primary colors of R (red), G (green), and B (blue) by three mirrors 2106 and two dichroic mirrors 2108 disposed inside the projector. The divided light is guided to light valves 100R, 100G, and 100B corresponding to the primary colors. The light of color B has a light pathway longer than that of color R or color G, and in order to prevent the loss thereof the color B is guided through a relay lens system 2121 including an incident lens 2122, a relay lens 2123, and an emitting lens 2124.

The structures of the light valves 100R, 100G, and 100 B correspond to the display unit 20 in the above-described embodiments. Here, the light valves are divided into R, G, and B. The light valves 100R, 100G, and 100B are driven on the basis of a video signal that is generated by processing a video signal Vid supplied from a higher-level device using the video signal processing apparatus 10.

The light modulated by the light valves 100R, 100G, and 100B is incident on a dichroic prism 2112 from three directions. In the dichroic prism 2112, the light of R and B is refracted by 90 degrees and the light of G continues in a straight line. Then, an image is composed from the images of each color, and the composed image is normally rotated to be projected on an enlarged scale by a lens unit 1820. Accordingly, a color image is displayed on a screen 2120.

While the images passing through the light valves 100R and 100B are projected after being reflected by the dichroic prism 2112, the image passing through the light valve 100G is directly projected. Thus, a horizontal scanning direction of the light valves 100R and 100B is reverse that of the light valve 100G. Accordingly, an image of color G is displayed as being horizontally inverted with respect to the images of colors R and B.

Furthermore, a liquid crystal display device according to an embodiment of the invention may be a direct view type such as a cellular phone, a personal computer, a television set, a monitor of a camcorder, a car navigator, a pager, an electronic diary, a calculator, a word processor, a workstation, a video phone, a POS terminal, a device having a touch panel, or the like, along with the device described above with reference to FIG. 11. The video display apparatus according to an embodiment of the invention may be applied to these electronic devices.

### Second Embodiment

A second embodiment of the invention will now be described. Hereinafter, descriptions for embodiments of the second embodiment common to those of the first embodiment will be omitted as needed.

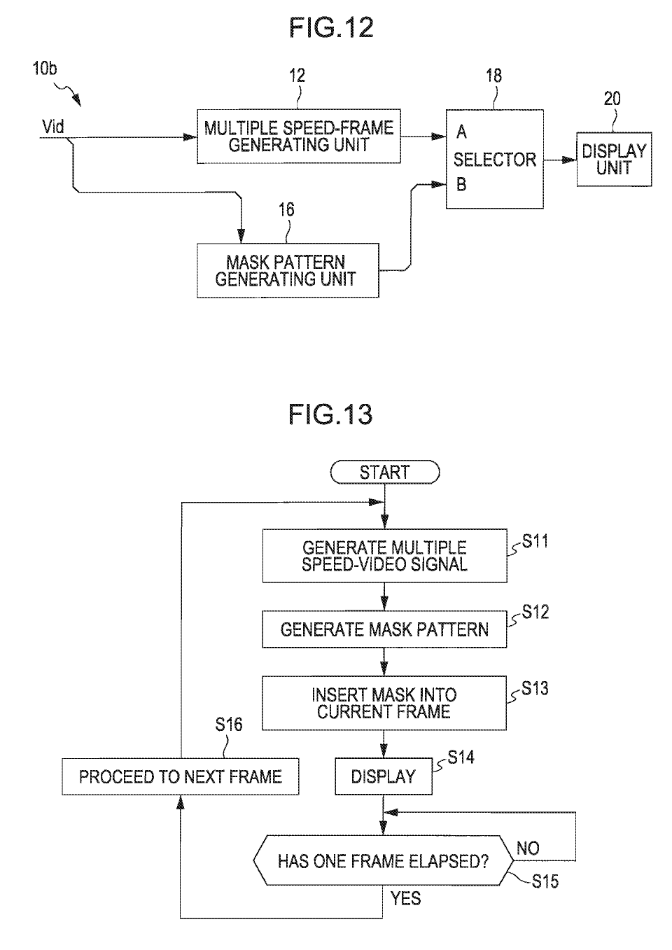

FIG. 12 is a diagram of a video signal processing apparatus for implementing a video display method according to the second embodiment.

As shown in the figure, the video signal processing apparatus 10b processes a video signal Vid supplied from an external higher-level device (not shown) and supplies the processed video signal to a display unit 20. For example, the video signal processing apparatus 10b that is connected to an input terminal of the display unit 20 as an adaptor includes a multiple-speed frame generating unit 12, a mask pattern generating unit 16, and a selector 18.

The reasons that the video signal Vid transmitted from the higher-level device is input to the mask pattern generating unit 16 are as follows. First, timing for generation of mask patterns is determined in accordance with supply of the video signal Vid that defines vertical scanning and horizontal a scanning. Second, to be described later, there are cases where black dots are concentrated in a moving area.

Next, operations of the video signal processing apparatus 10b will be described. FIG. 13 is a flowchart showing the operations of the video signal processing apparatus 10b.

In step S11, the multiple-speed frame generating unit 12 temporarily stores the video signal Vid supplied from the higher-level device in a memory. Thereafter, the multiple-speed frame generating unit 12 reads the video signal from the memory at a speed higher than a speed at which the video signal is stored. In this way, the multiple-speed frame generating unit 12 supplies a scan screen of one frame in a period half the one frame period. Since the selector 18 selects an input terminal A, for the m-th frame, the display unit 20 displays this scan screen from time t10 to time t11.

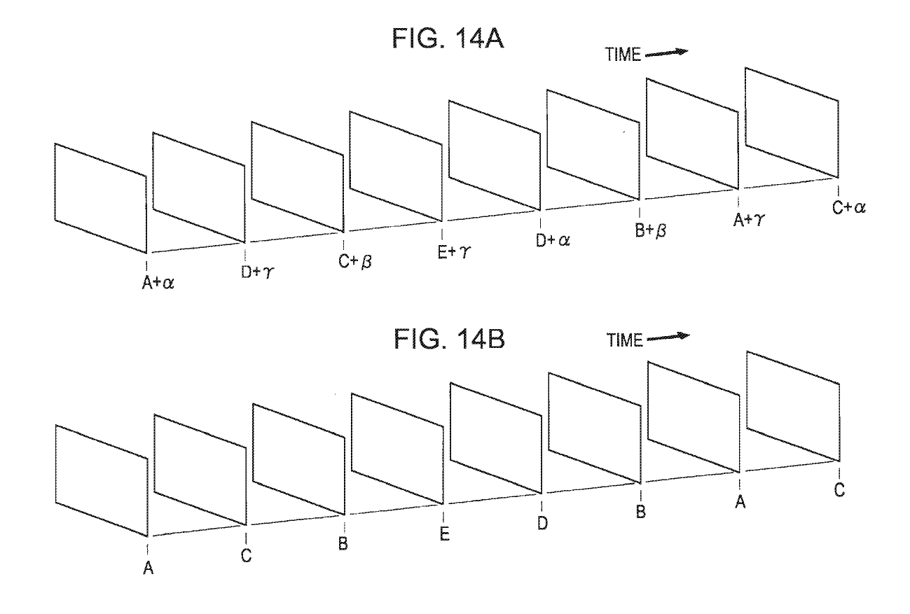

In step S12, the mask pattern generating unit 16 generates a mask pattern, for example, in the following method. In this embodiment, as shown in FIG. 8, five patterns in which places where the ratios of generation of black dots are increased are different from each other and three patterns, as shown in FIG. 9, in which the ratios of generation of black dots are different from each other are provided in advance. The mask pattern generating unit 16 changes combinations of the five patterns and the three patterns for each frame in a random order as shown in FIG. 14A. In this way, the mask pattern generating unit 16 generates the mask patterns. In FIG. 14A, for example, “A+α” indicates a combination of a pattern A shown in FIG. 8 and a pattern α shown in FIG. 9.

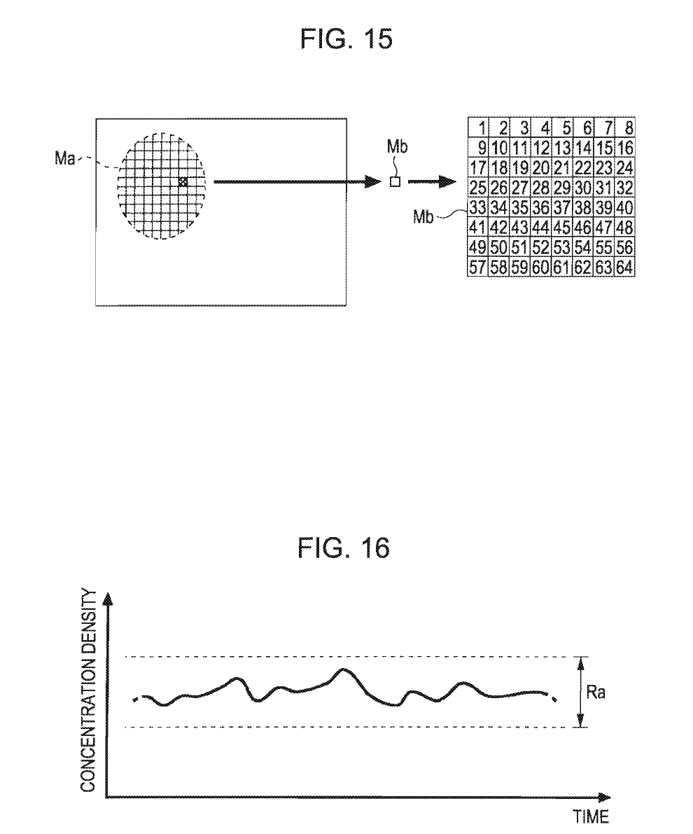

The five patterns shown in FIG. 8 and the three patterns shown in FIG. 9 are actually generated for each frame as follows. For example, in a case where a pattern A, in which a place where the proportion a of black dots generated is increased is located in an upper-left area of the screen, is to be generated, as shown in FIG. 15, the mask pattern generating unit 16 sets the upper-left area of the screen as an area Ma in which random dots are generated.

Next, the mask pattern generating unit 16 divides the area Ma, for example, into small areas Mb of 8×8 dots. Then, as shown in the figure, numbers of “1” to “64” are assigned to each dot of 8×8 dots of the divided small areas Mb. Then, the mask pattern generating unit 16 assigns numbers of “1” to “64” to each dot, to which a number is assigned, as random numbers. Then, the mask pattern generating unit 16 compares the assigned numbers (random numbers) with a threshold value and sets dots to which numbers equal to or greater than the threshold value are assigned in black. The mask pattern generating unit 16 performs the above-described operation for the whole divided small areas Mb.

Here, when the threshold value is decreased, the generated pattern close to the pattern α. To the contrary, when the threshold value is increased, the generated pattern is close to the γ pattern. In a case where a combination of the pattern A and the pattern α is used, it is preferable to set the threshold value to be a small value. On the other hand, in a case where a combination of the pattern A and the pattern γ is used, it is preferable to set the threshold value to be a large value. In a case where a combination of the pattern A and the pattern β is used, it is preferable to set the threshold value to be an intermediate value.

When the patterns B, C, D, and E are used, the mask pattern generating unit 16 sets the area Ma, in which the random dots are generated, on the upper-right, center, lower-left, and lower-right sides of the screen. It is preferable that the mask pattern generating unit 16 sets the threshold value on the basis of a combined pattern α, β, or γ.

Here, as shown in FIG. 14A, when the mask pattern is randomly changed for each frame, there is a possibility that brightness change of the screen due to change of concentration density of the mask pattern may be perceived. Thus, in this embodiment, the concentration density (a ratio of the number of black dots to the total number of dots) of the generated mask pattern, as shown in FIG. 16 is set to be in a predetermined range Ra. The actual range Ra is acquired by experiments.

Furthermore, the mask pattern generating unit 16 may extract moving areas in each frame from the video signals of the plurality of frames and generate the black dots adaptively so as to be included in the moving areas.

The mask pattern generating unit 16 supplies a video signal representing the generated mask pattern to the input terminal B of the selector 18 (step S13). At this moment, the selector 18 selects an input-terminal B. Thus, for the m-th frame, the display unit 20 displays an image of the mask pattern from time t12 to time t13. Accordingly, after the scan screen on the basis of the video signal Vid is displayed, a mask pattern for erasing retinal retention of the scan screen is displayed (step S14).

When it is determined that one frame period has not elapsed due to the supply of the video signal Vid (step S15: No), the multiple-speed frame generating unit 12 waits until the one frame period elapses. On the other hand, when it is determined that one frame period has elapsed (step S15: Yes), the multiple-speed frame generating unit 12 sets the next frame as a target frame to be processed in step S16. In other words, for example, a process in which a reading pointer (address) for the memory is set to a leading part of a video signal of the next frame or the like is performed.

Then, the process proceeds back to step S11. Accordingly, the process of steps S11 to S16 is repeated for each frame.

As described above, when a video signal Vid is input to the video signal processing apparatus 10b, a mask pattern that is inserted between scan screens on the basis of the video signal Vid is displayed in the display unit 20. Accordingly, generation of motion blur is suppressed.

Although the combinations of the five patterns shown in FIG. 8 and the three patterns shown in FIG. 9 are changed for each frame in the description above, more patterns may be combined and, as shown in FIG. 14B, only three patterns may be randomly changed. However, a condition that the concentration density is in the range Ra (see FIG. 16) should be satisfied.

The modified examples of the first embodiment described above may be applied to the second embodiment. Furthermore, the video signal processing apparatus 10b according to the second embodiment may be used in the video display apparatus shown in FIG. 11.

The entire disclosure of Japanese Patent Application Nos: 2006-270456, filed Oct. 2, 2006 and 2006-270457, filed Oct. 2, 2006 are expressly incorporated by reference herein.

What is claimed is:

1. A video display method used in a display device that displays images in correspondence with frames or fields defined by a video signal on the basis of the video signal, the video display method comprising:
generating mask patterns in correspondence with frames or fields defined by the video signal such that the mask patterns corresponding to consecutive frames or fields defined by the video signal are different from each other, the mask patterns including randomly arranged black and white dots or patterns; and
displaying at least one of the images on the basis of the video signal and then at least one of the generated mask patterns.

2. The video display method according to claim 1,
wherein the displaying of the at least one of the images is performed on the basis of a read video signal in a period shorter than that of the frame or field defined by the video signal by storing the video signal in a memory and then reading the video signal from the memory at a speed faster than a speed at which the video signal is stored, and
wherein the displaying of the at least one of the generated mask patterns includes displaying the at least one of the mask patterns at least for a part of a remaining period of the frame or field after the at least one of the images has been displayed on the basis of the read video signal.

3. The video display method according to claim 2, further comprising
displaying a white or gray image after displaying the at least one of the mask patterns for the part of the remaining period.

4. The video display method according to claim 1, further comprising:
detecting a moving area in the images on the basis of the video signal, the mask patterns being generated for the moving area and a peripheral area thereof of the frames or fields.

5. The video display method according to claim 4,
wherein the displaying of the at least one of the images is performed on the basis of a read video signal in a period shorter than that of the frame or field defined by the video signal by storing the video signal in a memory and then reading the video signal from the memory at speed faster than a speed at which the video signal is stored, and
wherein the displaying of the at least one of the generated mask patterns includes displaying the at least one of the mask patterns at least for a part of a remaining period of the frame or field after the at least one of the images has been displayed on the basis of the read video signal

6. The video display method according to claim 5, further comprising
displaying a white or gray image after displaying the mask pattern for the part of the remaining period.
